(19) United States
(12) Patent Application Publication
(10) Pub. No.: US 2026/0355693 A1
(43) Pub. Date: Nov. 12, 2026

(54) POTTING TECHNIQUE

(71) Applicant: WATERCYCLE TECHNOLOGIES LTD, Manchester (GB)

(72) Inventors: Sebastian LEAPER, Manchester (GB); Ahmed ABDELKARIM, Manchester (GB); Mathew ROCKEY, Manchester (GB)

(21) Appl. No.: 19/490,559

(22) PCT Filed: Jun. 6, 2024
(86) PCT No.: PCT/EP2024/065637

§ 371 Date: Dec. 5, 2025

(30) Foreign Application Priority Data
Jun. 7, 2023 (GB) 2308482.5

(51) Int. Cl. B01D 63/02

(52) U.S. Cl. CPC B01D 63/0224; B01D 63/0225; B01D 63/023

(57) ABSTRACT

Disclosed herein is a method of potting a hollow fiber bundle comprising a plurality of hollow fiber membranes, the method comprising a first potting step, a second potting step, and a cutting step to expose the bores of the hollow fiber membranes. The hollow fibre bundles produced by the method described herein are suitable for use in hollow fiber membrane modules.

### FIELD OF THE INVENTION

The present invention relates to a method of potting hollow fiber membranes.

### BACKGROUND

Hollow fiber membranes are widely used for separation applications such as haemodialysis, gas contacting and water treatment. They offer high specific surface areas (up to approximately 20,000 m2/m3) enabling high separation rates in a small volume of space.

For use in industrial processes, hollow fibers are typically bundled together within tubular modules, so as to allow parallel flow through many fibers simultaneously. As membrane processes require a separate input and output stream, the interior and exterior volumes of the hollow fibers need to be separated. This is done through the use of potting, which surrounds the hollow fibers yet does not block the interior volumes of said fibers. This potting (or gluing) process creates the fluid isolation between the feed (input) and permeate (output) sides of the membrane; this is fundamental to the operation of hollow fiber membrane modules. As the feed may be significantly pressurised, the seal must be strong in order to stop leakage around the interface between the membrane and potting compound.

Typically, two methods of potting membrane modules have been used. Chen et al. details both a static method and a centrifugal method.^{[}1]

The static method starts by immersing one end of a bundle of hollow fiber membranes in a potting compound and allowing it to harden. This forms a seal around the hollow fiber membranes and also blocks the bores of the fibers. The now-sealed end of the bundle is then immersed in a second potting compound; the bundle is submerged to a greater depth than for the first potting compound. As the bores are already sealed, the second potting compound cannot infiltrate further into the hollow fiber membrane. This allows for the outside (shell side) of the hollow fiber membranes to be covered by potting compound for a greater length than the inside (bore side) of the hollow fiber membranes. After allowing the second potting compound to harden, the sealed section of the bundle is cut (slightly above the depth of the first potting compound) so as to expose the internal bores of the hollow fiber membranes. By cutting the sealed section at a distance intermediate between the level of the first and second potting compounds, the shell side of the membranes will be covered in the potting compound but there will be no potting compound on the interior of the membranes. Thus, the fibers are held together while the flow paths through them (the bores) are maintained.

However, it has been noted that this static method is only suitable for a bundle comprising a low number of hollow fiber membranes (approximately less than 200), at relatively low density (approximately less than about 4 fibers/cm² to 50 fibers/cm² depending upon the diameters of the fibers). At higher numbers and densities of membranes, the potting compound cannot suitably infiltrate between and around the membranes to form a seal. This is due to the second potting compound only being able to infiltrate laterally between the fibers (perpendicular to the length of the fiber), as the first potting compound blocks the flow of the second potting compound up the length of the fibers. This is exacerbated by the curing of the second potting compound, which typically is proceeding at the same time as the immersion): as the second potting compound cures the viscosity increases which results in the central most fibers being less likely to be properly sealed.

For fiber bundles comprising a high number or density of hollow fiber membranes (approximately 200 or more in number and more than about 50 fibers/cm² in density), a centrifugal method is proposed. Centrifugal potting processes start by sealing both ends of a bundle of hollow fiber membranes with a first potting compound as for the static method. Then, the sealed bundle is placed into a tubular membrane module housing. This is then sealed at both ends to avoid leakage of the second potting compound. Next, the second potting compound is added to the membrane housing. This module (comprising the housing, membranes and liquid second potting compound) is then rotated at high speed such that centrifugal force acts in the direction of the fibers (this is, the module is rotated end over end). This forces the potting material radially outwards, towards the ends of the fibers to be sealed. Following the setting of the potting material, the membrane module is removed, and the ends of the fibers are cut off with a guillotine, removing the first potting compound and an amount of the second potting compound. This exposes the fibers, enabling access to the inside (bore) of the membranes.

The use of a centrifuge allows for a significantly higher acceleration to be applied to the potting compound when compared to the static method (which experiences acceleration due to gravity alone). This improves the infiltration of the potting compound around and between the hollow fiber membranes, forcing it in and amongst the fibers. Thus bundles having a larger number of fibers or higher density can be potted. Furthermore, potting compounds can be used that have a higher viscosity than those used for the static method; this also reduces the amount of wicking of the potting compound up the length of the hollow fiber membranes.

However, this centrifugal production method can be expensive. Set-up costs are high due to the requirement of a (often very large) centrifuge, and production costs are also high as the centrifugal process is energy-intensive. This centrifugal method also faces challenges when producing large modules and when using slower setting potting materials such as epoxy resin. To produce a large module (for example, 1.5 m in length) a centrifuge with a diameter of over 1.5 m is required. Furthermore, the energy required to rotate a large (and heavy) module is considerable. In addition, it is necessary to rotate the module for the duration of the curing time. Therefore, for slower setting resins, the module may have to be spun at high speed for lengths of time in excess of 24 hours. Especially for larger modules, this large amount of time spent in the centrifuge adds significant cost to the manufacturing process.

There is therefore need for an improved method of potting hollow fiber membrane modules that reduces waste membrane material, has a reduced environmental impact, has a lower cost, and has can be used with bundles comprising more membranes.

The present invention has been devised in light of the above considerations.

### SUMMARY OF THE INVENTION

The present inventors sought to provide an improved method of potting hollow fiber membranes. In doing so, the present inventors propose a method of potting hollow fiber membranes that can be performed without a centrifuge and can also reduce the waste produced during manufacturing.

In the method, the inner bores of the hollow fiber membranes are sealed using a first potting compound. For example, this can be done by immersing the ends of the hollow fiber membranes in molten wax. This first potting compound is suitably non-permanent (that is, it can be removed later in the method). This temporarily seals the ends of the individual hollow fiber membranes in order to prevent the hollow fiber membranes from being permanently blocked by the second potting compound.

After the ends of the hollow fiber membranes are sealed, the hollow fiber bundle is then placed in a mould along with a second potting compound. This second potting compound is a typical potting compound known in the art, that is, it forms a permanent seal around and in between the hollow fiber membranes. As the inner bores of the hollow fiber membranes are blocked with the first potting compound, the second potting compound cannot fill the interiors of the hollow fiber membranes. After the second potting compound is cured (or, if appropriate, dried, set or hardened), the hollow fiber bundle is removed from the mould.

The potted section is then cut across its cross section to expose the hollow fiber membranes. This may remove the entire section sealed with the first potting compounds (for example if the depth (distance from the end of the fibers) to which the first potting compound extends is less than the depth to which the second potting compound extends). Alternatively it does not, in which case the hollow fiber membranes will still be blocked by the first potting compound. To remove the first potting compound, heat and/or solvent can be used to selectively remove the first potting compound while leaving the second potting compound in place.

These steps can be repeated for the other end of the hollow fiber bundle to produce a potted hollow fiber bundle suitable for use in hollow fiber membrane modules.

At its broadest, herein described is a method of potting a hollow fiber bundle comprising a plurality of hollow fiber membranes, the method comprising the following steps:
(i) a first potting step comprising filling one end of the hollow fiber membranes of the hollow fiber bundle with a first potting compound and allowing the first potting compound to solidify so as to seal the ends of the hollow fiber membranes;
(ii) a second potting step comprising submerging the sealed end of the hollow fiber bundle in a liquid second potting compound and allowing the second potting compound to solidify so as to encase the sealed end of the hollow fiber bundle within the solid second potting compound;
(iii) a cutting step comprising cutting through the encased portions of the hollow fiber bundle so as to expose the bores of the hollow fiber membranes.

Typically, this process is performed on both ends of the hollow fiber bundle. Of course, it is clear that the invention can be performed in multiple equally effective permutations. For example, by sealing both ends of the hollow fiber membranes of the fiber bundle with the first potting compound in step (i), then performing steps (ii) and (iii) for each end of the fiber bundle. Another example includes performing steps (i) and (ii) for one end of the hollow fiber bundle, repeating steps (i) and (ii) for the other, non-potted end of the hollow fiber bundle, and then performing step (iii) for both ends of the hollow fiber bundle at the same time.

The first and second potting compounds are not particularly limited, any typical membrane potting compound as used in the art can be used in the present invention. For example, suitable potting compounds include epoxy resins, urethane resins and the like. As the first potting compound waxes and the like may be preferred.

In some aspects and embodiments of the invention, the first potting step comprises submerging one end of the hollow fiber membranes of the hollow fiber bundle in a liquid first potting compound. In some aspects and embodiments of the invention, the first potting step comprises agitating the hollow fiber bundle, before the first potting compound has solidified, so as to separate the hollow fiber membranes; and allowing the first potting compound to solidify so as to seal the ends of the hollow fiber membranes. Suitably, step (i) comprises an agitation step where the hollow fiber bundle is agitated so as to break apart any hollow fiber membranes that may have been bonded together by the first potting compound.

The agitation process may also remove some of the first potting compound from the shell side of the hollow fiber membranes. The agitation step means that the sealed end of the hollow fiber bundle is not a unitary mass (i.e. is not monolithic) with some paths through the sealed end of the bundle.

This agitation step can be done by various means, most simply shaking the bundle or by splitting the bundle by hand.

That is, in some embodiments the method comprises the steps of:
(i) a first potting step comprising filling one end of the hollow fiber membranes of the hollow fiber bundle with a first potting compound and allowing the first potting compound to solidify so as to seal the ends of the hollow fiber membranes, and then agitating the sealed end of the hollow fiber bundle;
(ii) a second potting step comprising submerging the sealed end of the hollow fiber bundle in a liquid second potting compound and allowing the second potting compound to solidify so as to encase the sealed end of the hollow fiber bundle within the solid second potting compound; and
(iii) a cutting step comprising cutting through the encased portions of the hollow fiber bundle so as to expose the bores of the hollow fiber membranes.

The inventors have found that this method can be effective in producing hollow fiber membrane modules, the method having the following advantages: as the bundle is agitated after the first potting step, the first potting compound does not form a unitary mass, this allows the infiltration of the second potting compound along the lengths of the fibers, and not only from the outer edge of the bundle. This allows for bundles containing high numbers of fibers, at high packing density, to be potted using the static method (that is, under gravity and without the need for centrifugation). This also allows for a more viscous second potting compound to be used thus reducing wicking without the need for a centrifuge.

In step (i), the ends of the fibers may be separated from one another before submersion in the first potting compound. This may mean that, after submersion (where present) and solidification, the first potting compound does not form a monolithic solidified mass and thus no additional separation after submersion (where present) and solidification (such as the above described agitation) may be needed.

That is, in preferred embodiments, the ends of the fibers are separated from one another either before submersion in (where present) and solidification of the first potting compound or after submersion in (where present) and solidification of the first potting compound. In some embodiments such separation is carried out both before and after submersion in (where present) and solidification of the first potting compound.

In step (i) the hollow fiber membranes of the hollow fiber bundle are filled to a first depth. In step (ii) the sealed end of the hollow fiber bundle is submerged in a liquid second potting compound and the second potting compound infiltrates to a second depth. [Depth here refers to the distance from the ends of the hollow fibers to the farthest extent of the relevant potting compound along the length of the fibers.]

If the first depth is less than the second depth, then the step (iii) may expose the unsealed bores of the hollow fibers, for example by cutting at a point between the first depth and the second depth.

Alternatively, if the first depth is greater than the second depth, then the step (iii) may expose bores of the hollow fibers sealed with the first potting compound, for example by cutting at a point closer to the ends of the hollow fibers than the second depth.

In some aspects and embodiments of the invention, the method comprises an additional step of:
(iv) a potting removal step comprising selectively removing the first potting compound from the bores of the hollow fiber membranes.

Suitably, this additional step is performed after performing step (iii), for example where the step (iii) exposes bores of the hollow fibers which are sealed with the first potting compound.

In aspects and embodiments comprising step (iv), the first potting compound is not particularly limited; suitably it can be removed from the hollow fiber membrane using heat and/or solvent without damaging the hollow fiber membrane material or the second potting compound. For example, suitable first potting compounds include low-melting point compounds such as waxes and soluble polymers such as polyvinyl alcohol.

That is, in some embodiments, the method comprises the steps of:
(i) a first potting step comprising filling one end of the hollow fiber membranes of the hollow fiber bundle with a first potting compound and allowing the first potting compound to solidify so as to seal the ends of the hollow fiber membranes;
(ii) a second potting step comprising submerging the sealed end of the hollow fiber bundle in a liquid second potting compound and allowing the second potting compound to solidify so as to encase the sealed end of the hollow fiber bundle within the solid second potting compound;
(iii) a cutting step comprising cutting through the encased portions of the hollow fiber bundle so as to expose the bores of the hollow fiber membranes; and
(iv) a potting removal step comprising selectively removing the first potting compound from the bores of the hollow fiber membranes.

The inventors have found that this method can be effective in producing hollow fiber membrane modules, the method having the following advantages: (1) the effective length of the hollow fiber membranes is not reduced. This is because the wicking of the first potting compound up the length of the hollow fiber membranes can be reversed (that is, the first potting compound can be removed without cutting); (2) by removing the first potting compound, there is no embrittlement of the hollow fiber membrane, this allows for low viscosity resins to be used; (3) as the first potting compound is removable, the amount of second potting compound required to seal the membrane module can be reduced.

In some embodiments, the method comprises both step (iv) and the first potting step comprises agitating the fibers.

That is, in some embodiments, the method comprises the steps of:
(i) a first potting step comprising filling one end of the hollow fiber membranes of the hollow fiber bundle with a first potting compound and allowing the first potting compound to solidify so as to seal the ends of the hollow fiber membranes and then agitating the sealed end of the hollow fiber bundle;
(ii) a second potting step comprising submerging the sealed end of the hollow fiber bundle in a liquid second potting compound and allowing the second potting compound to solidify so as to encase the sealed end of the hollow fiber bundle within the solid second potting compound;
(iii) a cutting step comprising cutting through the encased portions of the hollow fiber bundle so as to expose the bores of the hollow fiber membranes; and
(iv) a potting removal step comprising selectively removing the first potting compound from the bores of the hollow fiber membranes.

In some embodiments, step (i) is performed by first heating the first potting compound so as to liquify it, then dipping (that is, briefly immersing) one end of the hollow fiber bundle into the liquid first potting compound, and then allowing for the first potting compound to solidify. For example, step (i) can utilise a wax as a first potting compound. In other embodiments, the first potting compound is applied as a liquid that cures/sets/dries to give a solid. For example, the first potting compound can comprise polyvinyl alcohol.

In some embodiments, step (ii) is performed in a mould. The material and shape of the mould is not particularly limited. Typically, the mould will have a circular cross-section, but other shapes can equally be used. In some embodiments, the mould is made of a material that weakly bonds to the second potting compound, for example, low-friction engineering plastics such as PTFE, HDPE, PP, POM, nylon and the like. In some embodiments, a release compound is applied to the surface of the mould before the fiber bundle and second potting compound is added, this makes the removal of the solid second potting compound from the mould easier. Mould release compounds are well known in the art and the mould release compound used here is not particularly limited. For example, suitable mould release compounds include silicone-based compounds and graphite-based compounds.

As the hollow fiber membranes are typically porous (so as to enable fluid permeation and increase internal surface area), the second potting compound will naturally bond more strongly to the rough, porous surface of the membrane than to the mould which typically has a smooth non-porous surface (the smooth surface being a result of machining, for example).

In some embodiments, there is an optional additional step of binding the hollow fiber bundle before step (i) or step (ii). In the binding step, a netting material, tape, band or the like may be placed around the hollow fiber bundle prior to use of the second potting compound so as to ensure the fibers are held together and remain densely packed. This also provides some mechanical stability. Preferably, this is done before step (ii) and after step (i).

In the embodiment where the binding is done before step (i), the binding may be temporarily pulled up or moved along the length of the bundle while the hollow fiber bundle is immersed in the first potting compound to both prevent the binding from getting the first potting compound on it and to allow the fibers to be agitated, where that is done, thereby preventing the fibers from adhering to one another.

In some embodiments, the hollow fiber bundle is supported during step (ii). This can be done using any suitable supporting device such as a clamp stand and the like. This ensures that the fibers are held substantially upright and that when the potted end of the bundle is cut in step (iii), the fibers are substantially perpendicular to the cut surface. This is preferable as it allows for a smoother flow of liquid through the hollow fiber bundle when installed in a membrane module.

Step (iii) involves the removal of material from the end(s) of the potted fiber bundle so as to expose the end(s) and hence bores of the hollow fiber membranes within the matrix formed of the second potting compound. That is, the potted section is laterally cut so as to expose a cross section. In other words, the cross section of the hollow fibers is exposed in step (iii). This allows access to the inner bores of the hollow fiber membranes (either for usage or for removal of the first potting compound, followed by usage). Suitably, this cutting step can be performed by any suitable means, for example by use of a guillotine or saw.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a diagrammatical representation of the method of the invention.

FIG. 2 shows: (a) a hollow fiber bundle after step (ii); (b) the same bundle after step (iii); and (c) the same bundle after step (iv).

FIG. 3 shows a diagrammatical representation of the static method of the prior art (a-c), and a static method of the invention (d-g).

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

### Hollow Fiber Membranes

Each hollow fiber membrane is, as is well known, in the form of an elongate fiber member with a substantially circular cross section. Taking a plurality of these hollow fiber membranes together, with their longitudinal axes aligned, forms a hollow fiber bundle.

Hollow fiber membranes can be provided in any desired length by known production means. Typically, individual fibers are between 0.1 to 1.5 m in length, however the method of the invention can be used with individual fibers of large lengths, for example up to 5 m in length. As material is removed from the ends of the potted hollow fiber bundle in step (iii), the hollow fiber membranes of the finished hollow fiber membrane module are typically shorter than those forming the hollow fiber bundle at the start of the method.

Hollow fiber membranes have an outer diameter and an inner diameter, thereby defining a wall. Herein, the outer diameter or shell diameter is referred to as “D”; the inner diameter or bore diameter is referred to as “d”. The wall thickness is therefore half the difference between the outer diameter and the inner diameter (that is, the wall thickness=(D−d)/2). The hollow fiber membranes may be characterised by either both the outer and inner diameters, or by the wall thickness and one of the outer or inner diameters. The hollow fibers can also be defined by wall thickness, outer and inner diameter.

The hollow fibers themselves may preferably be in the form of permeable membranes, comprising a porous matrix material. In use, these membranes allow for the permeation of solvent through the membrane, by increasing the porosity of the membrane permeability and internal surface area can be increased.

The hollow fibers themselves may preferably be in the form of adsorptive membranes, comprising a matrix material and a selective adsorption material. In use, these membranes do not allow the permeation of solvent through the porous membrane, but rather selectively uptake (adsorb) material from the feed solution to then be recovered in a second release step.

The material of the hollow fiber membrane is not particularly limited. Suitably the membranes comprise a matrix material that provides the structure of the hollow fiber membrane. The membranes may also optionally comprise absorbent materials dispersed throughout the matrix material.

In some preferred embodiments the membrane comprises one or more polymeric matrix materials. Suitable polymers include polysulfone (PSU), polyethersulfone (PES), polyketone (PK), polyetherketone (PEK), polyetheretherketone (PEEK), polyetherketoneketone (PEKK), polyvinylidene difluoride (PVDF), polypropylene (PP), polyethylene terephthalate (PET), high-density polyethylene (HDPE), ultra-high-molecular-weight polyethylene (UHMWPE) and polyimide.

In some preferred embodiments the membrane comprises a ceramic matrix material. Suitable ceramic matrix materials include alumina (Al₂O3) and zirconia (ZrO₂).

“Adsorbent material” is used to refer to a material that can selectively adsorb species from solution. This can occur through physical adsorption of species onto surfaces and into pores of the adsorbent material. It can also occur through chemical adsorption through the incorporation of species into a crystal structure or by ion-exchange.

The adsorbent material may suitably be provided in the form of particles. In some embodiments, the particle size of the selective material is ≤50 μm, suitably ≤25 μm, or ≤10 μm. Most suitable is a particle size of ≤5 μm, or ≤3 μm. On the other hand, the particles may suitably have a size of ≥200 nm, for example ≥400 nm, ≥1 μm, or ≥2 μm.

In one embodiment, the adsorbent material is a lithium-ion sieve (LIS). It may alternatively be a potassium ion sieve or a calcium ion sieve. Suitable lithium-ion sieves include, but are not limited to, zeolites, metal organic frameworks, layered double hydroxides, lithium metal oxides such as lithium manganese oxide and lithium titanium oxide, and the like.

In embodiments where the hollow fiber membrane is an absorptive membrane, the matrix material preferably comprises or consists of polyethersulfone (PES). The selective adsorption material may be any known in the art to have a selective adsorption or ion-exchange activity for a desired component. For example, it may be an ion selective material. In some embodiments, where the intended feedstock is a lithium-containing solution, lithium metal oxides and the products formed from ion exchange of the lithium in them with hydrogen (e.g. by a pre-treatment with a protic acid, to form a hydrogen metal oxide derived from the lithium metal oxide) are particularly suitable for use as a lithium selective material held in the matrix material. Lithium manganese oxide (LMO) and hydrogen manganese oxide (HMO) derived from LMO, and lithium titanium oxide (LTO) and hydrogen titanium oxide (HTO) derived from LTO are suitable examples. Preferably the ion selective material comprises LTO or HTO. That is particularly the case where the matrix material is PES.

In some embodiments, the hollow fiber membrane is porous. Preferably the hollow fiber membranes preferably have a porosity ≥60%. More preferably, the membranes have a porosity ≥70%. A porosity of about 80% may be particularly suitable. The pores of the membranes may have a size (D50) of ≤2 um, for example ≤1 μm. A pore size of 10-40 nm may be particularly suitable.

The outer diameter (D) and the inner diameter (d) of the fiber is not particularly limited; as explained above, as the ends of the hollow fiber membranes are blocked with the first potting compound there will be no infiltration of the second potting compound into the bores of the fibers regardless of the bore size. Nevertheless, a suitable range of d is 100-1000 μm; a suitable range for D is 200-2000 μm.

The wall thickness (that is, half the difference between the outer diameter and inner diameter; [D-d]/2) is not particularly limited; in some embodiments it is 20-200 μm.

The length of the fiber is not particularly limited; as discussed above, this is one benefit of the method of the invention when compared to the known centrifugal method—that is, any length can be used.

### Hollow Fiber Modules

The number of hollow fibers in a bundle is not particularly limited. Optionally, the bundle comprises more than 10 fibers. Optionally, more than 50 fibers. Optionally, more than 100 fibers. Optionally, more than 150 fibers. Optionally, more than 200 fibers. Optionally, more than 300 fibers. Optionally, more than 400 fibers. Optionally, more than 500 fibers. Optionally, more than 1000 fibers. Optionally, the bundle comprises fewer than 10000 fibers. Optionally, fewer than 5000 fibers. Optionally, fewer than 3000 fibers. Optionally, fewer than 2000 fibers. Optionally, fewer than 1000 fibers. Typically, there may be between 10 and 10000 fibers bundled together. Optionally, between 100 and 5000 fibers. Optionally, between 200 and 3000 fibers. Optionally, between 500 and 2000 fibers. Of course, the number of fibers that can be contained within a given fiber membrane module will depend on the outer diameter (that is the thickness) of the hollow fiber membranes.

The density of hollow fibers in a bundle is also not particularly limited (density being measured as number of fibers per cm² in an end-on cross sectional view of the bundle). Optionally, the bundle contains hollow fiber membranes at a density of more than about 4 fibers/cm², optionally more than about 10 fibers/cm², optionally more than about 20 fibers/cm², optionally more than about 30 fibers/cm², optionally more than about 40 fibers/cm², optionally more than about 50 fibers/cm², optionally more than about 60 fibers/cm², optionally more than about 70 fibers/cm², optionally more than about 90 fibers/cm², optionally more than about 100 fibers/cm². Optionally the bundle contains hollow fibers at a density of about 100 fibers/cm² or less, optionally about 90 fibers/cm² or less, optionally about 80 fibers/cm² or less optionally about 70 fibers/cm² or less, optionally about 60 fibers/cm² or less, optionally about 50 fibers/cm² or less. Optionally the bundle contains fibers at a density from about 4 to about 100 fibers/cm², optionally from about 10 to about 100 fibers/cm², from about 30 to about 100 fibers/cm², from about 50 to about 100 fibers/cm².

Depending on the outer diameter of the fiber, there may be more or fewer fibers in a bundle. Optionally, the diameter of the bundle is between 1 and 50 cm; optionally between 10 and 20 cm.

The potted membrane bundle produced by the present invention is largely the same as those produced by the centrifugal method. However the membrane modules produced by the present invention may have a larger effective surface area for a given volume when compared to those of the prior art due to the reduction in wicking of potting compound up the membranes.

Typically, the potted sections have a thickness (in the direction along the length of the fibers) of more than 1 mm, optionally more than 2 mm, optionally more than 5 mm, optionally more than 10 mm, optionally more than 20 mm, optionally more than 50 mm, Optionally the potted sections have a thickness of 100 mm or less, optionally 50 mm or less, optionally 20 mm or less, optionally 10 mm or less, optionally 5 mm or less,

Typically the potted sections have a thickness from 1 to 100 mm, optionally from 5 to 50 mm.

Typically, the membrane bundle comprises up to 10,000 individual fibers, preferably more than 100 fibers, more preferably more than 500 fibers. That is, the hollow fiber membrane bundle used in steps (i) to (iii) contains this amount of fibers.

The potted hollow fiber bundle produced by the method of the present invention is suitable for use in known hollow fiber membrane housings. Suitably, the potted ends of the fiber bundle can be sealed into the housing using a sealant such as glue, or by using compression fittings. The potted hollow fiber bundle has the advantage that it can be produced without being integral to the housing. This allows for the replacement of the hollow fiber bundle within the housing without also replacing the housing, which reduces waste.

### First Potting Compound

The first potting compound is not particularly limited, and can suitably be any conventional potting compound. This includes both thermosetting and thermoplastic polymers.

In some embodiments, the first potting compound comprises wax. The wax is not particularly limited, for example the wax can comprise one or more of: animal waxes, such as beeswax, Chinese wax, lanolin, and shellac; vegetable waxes, such as carnauba wax, castor wax, rice bran wax, and soy wax; and petroleum waxes such as candle wax, microcrystalline wax, montan wax, ozocerite, petrolatum and paraffin wax. Optionally the wax comprises one or more petroleum waxes. Optionally the wax is one or more of paraffin wax, microcrystalline wax and petrolatum. Optionally the wax is candle wax.

Such a wax is, as is well known, primarily made up of simple alkane hydrocarbons having the general formula CₙH₂ₙ₊₂ where n is the number of carbon atoms in the chain. Typically the hydrocarbons are mostly straight chain. However the exact content of a given wax is difficult to exactly enumerate. For example, paraffin waxes are commonly mixtures of saturated n-and iso-alkanes, naphthenes, and alkyl-and naphthene-substituted aromatic compounds.

When deriving waxes from crude oil, the final content may depend on the refining process and crude oil condition. For example, there may be produced some mixture of paraffin wax (this wax has a melting point ranging from 45 to 70 °C; these are typically straight-chain hydrocarbons), microcrystalline wax (these are used as additives and are typically mixtures of saturated hydrocarbons with a higher melting point) and petrolatum (soft wax made from a combination of wax and oil).

Use of a wax may be particularly preferable where the present methods comprise an agitation step after submerging the hollow fibers in the first potting compound and solidifying the first potting compound. Many waxes solidify in a brittle state; that is, while solid, they are easily broken, shattered or at least cracked. This can mean that an agitation step easily separates the fibers after solidification of the first potting compound, or creates cracks into which the second potting compound can flow between the fibers. The brittle wax can more easily be removed from the hollow fibers without damaging those fibers. On the other hand, fast cure epoxy resins of the type often used in the prior art are more difficult to remove, crack or separate, potentially leading to damage or breakage of the hollow fibers.

In some embodiments, the first potting compound comprises a thermoplastic polymer. Suitable thermoplastic polymers include: polyolefins, such a polyethylene and polypropylene; polyesters such as polyethylene terephthalate; polyamide resins such as polycaproamide (nylon 6), polyhexamethylene adipamide (nylon 66); polycarbonate resin, polyphenylene sulfide (PPS), polyacetal resin, polyoxymethylene (POM), polyimide, polyamide-imide (PAI), polyetherimide (PEI), polysulfone (PS), polyethersulfone (PES), polyether ketone (PEK), polyetherether ketone (PEEK), and polyetherketone ketone (PEKK).

Thermoplastic resins can be applied in the liquid, molten state and allowed to cool, thereby providing a solid polymer as the first potting compound.

In some embodiments, the first potting compound comprises a thermosetting polymer (also called a resin). Suitable thermosetting polymers include: epoxy resins, such as a bisphenol epoxy resins, novolak epoxy resins; acrylic resins; unsaturated polyester resins; urea-melamine resins; polyimide resins; polyurea resins; polyurethane resins; and cyanate resins.

Thermosetting resins can be applied as a precursor material comprising one or more components and then set/cured using heat, visible light, UV light, activators and the like to provide a cured first potting compound.

In embodiments comprising step (iv), the first potting compound can suitably be removed from the bore of the hollow fiber membranes using heat and/or solvent without causing damage to the membranes or to the second potting compound.

Therefore, materials having a low melting point can be used, preferably with a melting point below 150 °C, preferably below 120 °C, preferably below 100 °C, preferably below 80 °C, preferably below 60 °C. In terms of handleability, it is preferred that the melting point is above 15 °C, preferably above 20 °C, preferably above 25 °C, preferably above 30 °C.

In other embodiments, the first potting compound can be applied as a liquid that then cures (or dries or sets) to provide a solid material. This is not particularly limited given that the solid first potting compound can suitably be removed using a solvent. It is preferable that the solvent is water.

In some embodiments the first potting compound comprises polyvinyl alcohol (PVA), polyvinyl acetate (PVAc), high molecular weight polyethylene glycol (PEG), and polyurethanes.

The viscosity of the first potting compound is not particularly limited, as there the first potting compound can flow, without obstruction, into the bores of the hollow fiber membranes.

Typically ‘low viscosity’ resins used in the art are liquid at room temperature and have (dynamic) viscosities of between 10 to 1,000 cP at 25 °C (1 centipoise (cP)=1 millipascal second (mPa·s)).

Of course, viscosity is dependent on temperature and first potting compound may typically be made less viscous through heating (as for waxes and thermoplastics, which need to be melted/softened before application). Furthermore, viscosity will increase over time as the potting compound solidifies.

For example, paraffin wax (candle wax) has a viscosity of about 7 cP at 60 °C and reduces to about 3 cP at 100 °C.

### Second Potting Compound

The second potting compound is not particularly limited and can suitably be any conventional membrane potting compound. This includes both thermosetting and thermoplastic polymers.

In some embodiments, the second potting compound comprises a thermoplastic polymer. Suitable thermoplastic polymers include: polyolefins, such a polyethylene and polypropylene; polyesters such as polyethylene terephthalate; polyamide resins such as polycaproamide (nylon 6), polyhexamethylene adipamide (nylon 66); polycarbonate resin, polyphenylene sulfide (PPS), polyacetal resin, polyoxymethylene (POM), polyimide, polyamide-imide (PAI), polyetherimide (PEI), polysulfone (PS), polyethersulfone (PES), polyether ketone (PEK), polyetherether ketone (PEEK), and polyetherketone ketone (PEKK).

Thermoplastic resins can be applied in the liquid, molten state and allowed to cool, thereby providing a solid polymer as the second potting compound.

In some embodiments, the second potting compound comprises a thermosetting polymer (also called a resin). Suitable thermosetting polymers include: epoxy resins, such as a bisphenol epoxy resins, novolak epoxy resins; acrylic resins; unsaturated polyester resins; urea-melamine resins; polyimide resins; polyurea resins; polyurethane resins; and cyanate resins.

Thermosetting resins can be applied as a precursor material comprising one or more components and then set/cured using heat, visible light, UV light, activators and the like to provide a cured second potting compound.

The viscosity of the second potting compound is not particularly limited, as the method of the invention improves the flow of the second potting compound in and around the sealed hollow fiber membranes.

Therefore, ‘high viscosity’ resins can be used that would typically require centrifugation for sufficient penetration. Typically ‘high viscosity’ resins used in the art are liquid at room temperature and have (dynamic) viscosities of between 750 to 5,000 cP at 25 °C. Of course, viscosity will increase over time as the potting compound solidifies.

Furthermore, viscosity is dependent on temperature and resins may typically be made less viscous through heating. However, typically the second potting compound is a curable resin that is liquid at room temperature, although molten thermoplastics and the like can still be used.

In some embodiments, the second potting compound is a ‘high viscosity’potting compound.

For curable resins that are applied at room temperature, these ‘high viscosity’ resins have (dynamic) viscosities (at 25 °C) of above 100 cP, optionally above 200 cP, optionally above 500 cP, optionally above 1,000 cP, optionally above 2,000 cP, optionally above 5,000 cP, optionally above 10,000 cP, optionally above 20,000 cP, optionally above 50,000 cP, optionally above 100,000 cP.

For ‘high viscosity’ potting compounds that are thermoplastics applied in the molten state, these have (dynamic) viscosities which are highly dependent on temperature. Thermoplastic resins can be applied at temperatures that result in a viscosity of above 100 cP, optionally above 200 cP, optionally above 500 cP, optionally above 1,000 cP, optionally above 2,000 cP, optionally above 5,000 cP, optionally above 10,000 cP, optionally above 20,000 cP, optionally above 50,000 cP, optionally above 100,000 cP.

Optionally, the viscosity, at the time of application, of the second potting compound is between 100-100,000 cP, optionally between 200-50,000 cP, optionally between 300-10,000 cP, optionally between 500-10,000 cP, optionally between 1,000-10,000 cP, optionally between 3,000-10,000 cP.

### Step (i)

Step (i) of the method of the invention comprises sealing (by filling) one end of the hollow fibers membranes of the hollow fiber bundle with a first potting compound.

In some embodiments, this is performed by submerging the one end of the hollow fiber bundle within a liquid first potting compound. The liquid first potting compound can be formed by melting the first potting compound (for example, a wax or thermoplastic polymer), or it can be a precursor that cures/dries/sets to provide the first potting compound (for example, a solution of PVA or thermosetting polymer).

In other embodiments, where the first potting compound is malleable (for example, paraffin wax), this can be done by pressing the hollow fiber membrane into the first potting compound.

The amount of the hollow fiber membranes that is sealed with the first potting compound is not particularly limited, as long as a seal is formed at the end of the fiber so as to inhibit the second potting compound from filling the bore of the hollow fiber membrane. In some embodiments, the entire length of the hollow fiber is filled with the first potting compound. In some embodiments, only a portion of the hollow fiber membrane is filled with the first potting compound. For example, the hollow fibers may be filled to a first depth.

In some embodiments, the first potting compound fills the bore of the hollow fiber at a length (depth) of 0.1 cm or more from the end of the hollow fiber membrane. Optionally 0.2 cm or more. Optionally 0.3 cm or more. Optionally 0.5 cm or more. Optionally 1 cm or more. Optionally 2 cm or more. Optionally 3 cm or more.

In some embodiments, the ends of the hollow fiber membranes are submerged at a depth of 0.5 cm or more within the liquid first potting compound. Optionally 1 cm or more. Optionally 2 cm or more. Optionally 3 cm or more.

In some embodiments, the first potting step is performed in a mould. Optionally, the mould comprises or is made of a low-friction material, this reduces the adhesion of the first potting compound to the mould.

This makes the removal of the hollow fiber bundle from the mould easier. Suitable mould materials include polytetrafluorethylene (PTFE), polyvinylidene fluoride (PVDF), polyvinyl fluoride (PVF), polyoxymethylene (POM), high-density polyethylene (HDPE), ultra-high molecular weight polyethylene (UHMWPE), nylon, and polyphenylene sulfide (PES).

In some embodiments, a separation step is performed before sealing the ends of the hollow fiber membranes with the first potting compound; in this step, the ends of the hollow fibers are separated before the separated ends are sealed. This can mean that the fibers are not sealed together; that is, they are sealed individually but not as a monolithic block. After solidification of the first potting compound, there are thus pathways through the first potting compound lying between the various hollow fiber ends.

In some embodiments, an agitation step is performed after sealing the ends of the hollow fiber membranes with the first potting compound. Suitably, the agitation step introduces paths up through the sealed section of the hollow fiber bundle in the direction of the hollow fiber membranes. In other words, the entirety of the hollow fiber membranes are not potted in a single monolithic piece of the hardened first potting compound.

In some embodiments, the agitation step involves the removal of the first potting compound from the shell side of the hollow fiber membranes. For example, when first potting compounds are used which are soft or brittle in the hardened state (for examples waxes), agitation of the hollow fiber membranes may be sufficient to break or crack the hardened first potting compound from the outside shells of the hollow fiber membranes, while the hardened first potting compound within the bores of the membranes is unaffected. In some embodiments, the first potting compound is substantially or entirely removed from the shell side of the hollow fiber membranes by the agitation step.

In some embodiments, the agitation step comprises vibrating the entire hollow fiber bundle. This can be achieved by placing the hollow fiber membrane into a tumbler, or by placing it on a shaking or vibrating plate. In some embodiments the agitation step comprises manually (that is, by-hand) picking apart the individual fibers.

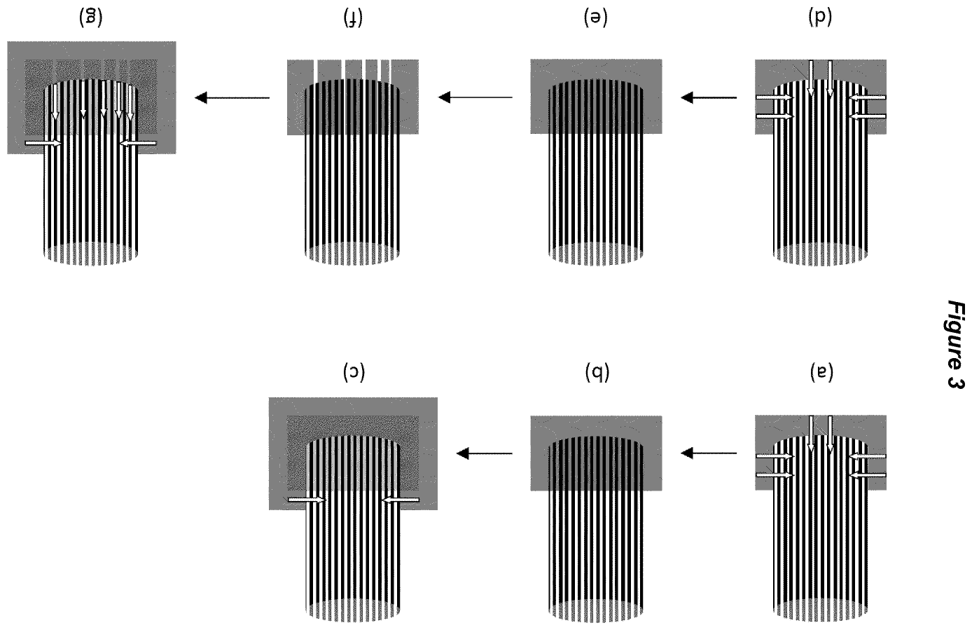

As can be seen from FIGS. 3a-c and FIGS. 3d-g, the agitation step improves the infiltration of the second potting into the hollow fiber bundle.

FIG. 3a-c show the steps of the method of the prior art. In the first potting step (FIG. 3a), the first potting compound can enter into the hollow fiber bundle both laterally (perpendicularly to the length of the fibers) and axially (parallel to the length of the fibers). However, in the second potting step (FIG. 3c), the unitary mass of first potting compound obscures the axial pathway into the hollow fiber bundle. The second potting compound can only infiltrate the bundle laterally, where at high densities of hollow fibers, the tortuous path significantly hinders the flow of second potting compound into the bundle. This limits the size and packing density of the fiber bundle, as when the bundle comprises many hollow fiber membranes or they are too densely packed, the path to the centre of the bundle is too great or tortuous for the second potting compound to fully seal the bundle before the resin has cured or hardened.

In comparison, FIGS. 3d-g show the steps of the method of the invention wherein the method comprises an agitation step (FIGS. 3e-f). As for the prior art method, the first potting compound can easily flow into the hollow fiber bundle (FIG. 3d). However, by agitating the bundle after immersing in the first potting compound, if effect, paths through the first potting compound are formed (FIG. 3f).

Either by removing some of the first potting compound from the shell side of the fibers or by forming cracks through the first potting compound. This then allows for the second potting compound to flow axially though the fibers as for the first potting compound (FIG. 3g).

As the path length from the bottom of the fibers (that is the axial path) through the first potting compound remains the same for a bundle of larger fibers (where in contrast the lateral path length increases with the radius of the bundle) therefore the method comprising an agitation step can be used for bundles comprising a larger number of fibers, at a higher density, than the method of the prior art.

### Step (ii)

Step (ii) of the method of the invention comprises submerging the sealed end of the hollow fiber bundle (that is, the ends of the membranes filled with the first potting compound) in a liquid second potting compound and allowing the second potting compound to solidify so as to encase the ends of hollow fiber membranes in the solid second potting compound.

The amount of the hollow fiber membranes that is sealed with the second potting compound is not particularly limited. In some embodiments, the length of hollow fiber membrane encased in the second potting compound (a second depth) is greater than the length of hollow fiber membrane filled with the first potting compound (that is, the first depth).

In some embodiments wherein the method comprises step (iv), the length of the hollow fiber membrane can be the same, in other embodiments the length is less.

In some embodiments, the second potting step is performed in a mould. Optionally, the mould comprises or is made of a low-friction material; this reduces the adhesion of the second potting compound to the mould. This makes the removal of the hollow fiber bundle from the mould easier. Suitable mould materials include polytetrafluorethylene (PTFE), polyvinylidene fluoride (PVDF), polyvinyl fluoride (PVF), polyoxymethylene (POM), high-density polyethylene (HDPE), ultra-high molecular weight polyethylene (UHMWPE), nylon, and polyphenylene sulfide (PES).

Step (iii)

Step (iii) of the method of the invention comprises cutting through the encased portion of the hollow fiber bundle so as to expose the ends of the hollow fiber membranes within the encased portion. In some embodiments, this may be done such that the bores of the hollow fiber membranes are accessible after the cutting step. This can be done using any suitable means such as using a guillotine or a saw.

It may be preferred that the minimum amount of material is removed so as to expose all the hollow fiber membrane bores. Typically, about 0.1 to 3 cm of the potted portion (measured from the distal end of the potted section) is removed in step (iii). preferably about 0.1 to 1 cm of the potted portion is removed. In some embodiments, an amount of the encased portion is removed so as to leave at least a potted portion with a thickness of at least 2 cm so as to provide a suitable surface to seal inside a complete hollow fiber membrane module.

In some embodiments, the potted portion is cut at a point where the hollow fibres are not filled with the first potting compound but are encapsulated within the second potting compound (between the first depth and the second depth), thus exposing unfilled/unsealed bores of the fibers.

In some embodiments, where the method comprises step (iv), the potted portion is cut at a point where the hollow fibers are filled with the first potting compound (closer to the ends of the hollow fibers than both the first and second depths). That is, they are cut at a length from the end of the hollow fiber bundle that is less than the depth of filling with the first potting compound.

### Step (iv)

Optionally, the method comprises an additional step, step (iv). This optional step comprises selectively removing the first potting compound from the hollow fiber membranes through the use of heat and/or solvent.

In embodiments where the first potting compound is applied in a molten state, the removal of the first potting compound in step (iv) can suitably be done through the application of heat, so as to revert the first potting compound back to a liquid state; it can then drip or be sucked out of the bores, for example. In some embodiments, a solvent can also be used with the application of heat so as assist the removal of the first potting compound. In these embodiments, the removed first potting compound can be reused in later process as the first potting compound in step (i).

In some embodiments the whole module is heated so as to liquify the first potting compound, allowing it to flow out of the bores of the hollow fiber membranes, leaving them substantially free of the first potting compound. This can be done by, for example placing the membrane module upright (that is, with the lengths of the fibers vertical) in an oven at an elevated temperature. The first potting compound will then melt and flow out of the bores of the hollow fiber membranes under gravity. The temperature of the oven is preferably above the melting point of the first potting compound, but below the melting/degradation point of the hollow fiber membrane material and that of the second potting compound. For example, the oven temperature is preferably between 50 to 150 °C.

In embodiments where the first potting compound is applied as a curable liquid, the removal of the first potting compound in step (iv) can suitably be done through the application of a solvent so as to dissolve the cured first potting compound. In some embodiments, the application of heat can be used alongside solvent so as assist the removal of the first potting compound.

In some embodiments, the first potting compound can be removed using solvent. For example, the hollow fibers may be flushed with the solvent, or the whole hollow fiber module may be placed in a solvent bath. In some embodiments the solvent is held at an elevated temperature (that is, above ambient or room temperature).

In embodiments where the first potting compound comprises a wax, non-polar solvents can be used. Suitable solvents include benzene, toluene, xylene, pentane, hexane, heptane, petroleum ether, dioxane, diethyl ether, chloroform and the like.

In some embodiments, water can be used to remove the first potting compound. For example, when the first potting compound comprises PVA, PVAc, PEG.

### Method of the Invention

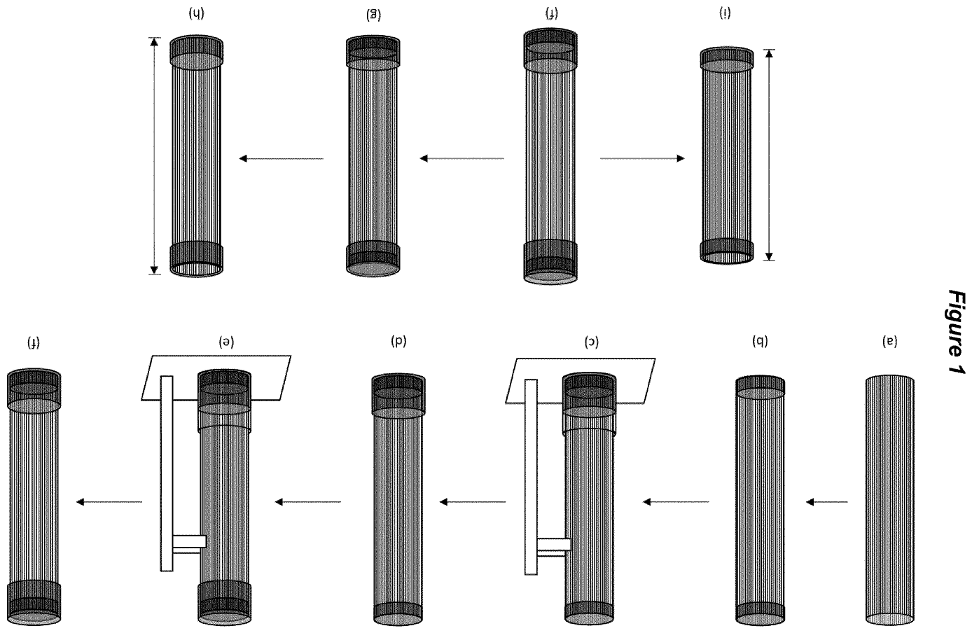

An example potting process according to the invention is shown in FIG. 1 and comprises the following sequential steps:
1. A hollow fiber bundle is formed from grouping a number of hollow fiber membranes together (FIG. 1a).
2. The hollow fiber membranes are sealed at one end by submerging one end of the hollow fiber bundle in molten candle wax (the first potting compound).
3. The bundle is then removed from the wax and, before the wax solidifies, the bundle is agitated to break apart the wax and to ensure the hollow fiber membranes are not joined together by the wax.
4. Steps 2 and 3 are repeated for the other, non-sealed end of the hollow fiber bundle to provide a hollow fiber bundle of hollow fiber membranes which are sealed at both ends (FIG. 1b).
5. A low viscosity adhesive (the second potting compound) is inserted into a potting assembly which is made from a material that does not bond to the potting adhesive (e.g. HDPE, PP, PTFE). Lubricant such as grease, or a mould release compound, may be applied to the walls and base of the assembly to enable easy removal after curing.
6. One end of the sealed membrane bundle of step 4 is then inserted into the potting assembly such that the membranes are submerged in the epoxy resin so that the ends sealed in step 4 are completely submerged. The membrane bundle is then supported vertically by a support frame until the epoxy resin has cured.
7. After the second potting compound has cured, the membrane bundle is removed from the potting assembly (FIG. 1d).
8. Steps 5-7 are then repeated for the opposite end (the end not potted in the second potting compound) of the hollow fiber membrane bundle (FIGS. 1e and 1f).
9. The wax-filled bores of the hollow fiber membranes are then exposed by laterally cutting through the potted sections with a guillotine or saw, so as to remove only a section of the hollow fiber bundle filled with wax (FIG. 31).
10. The wax is then removed from the bores of the membranes via melting, so as to expose the bores of the hollow fiber membranes (FIG. 1h).

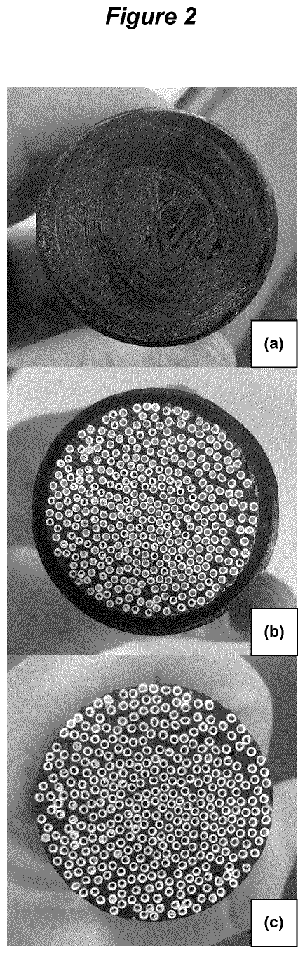

As can be seen in FIG. 2a, after the second potting compound has cured and the hollow fiber bundle is removed from the potting assembly (step 7), the ends of the hollow fiber membranes are not visible (that is, you cannot see the bores or the walls of the membranes). FIG. 2b shows the potting section after being cut across the cross-section (step 9), it can be seen that the ends of the hollow fibers are visible, with the walls and bores being clearly identifiable, it can also be seen that the bores of the hollow fiber membranes are filled with wax. FIG. 2c shows the end of the hollow fiber bundle after the removal of the wax by use of heat (step 10), it can be seen that the bores of the membranes are empty (that is, there is no wax filling them.

Alternately, steps 1-8 can be performed as above, and then the step of:
11. The bores of the hollow fiber membranes are then exposed by laterally cutting through the potted sections with a guillotine or saw, so as to remove the entire portion of the hollow fiber bundle filled with wax. This process removes the sections of the fiber filled with wax but still retains a sufficient depth of potting material to ensure the hollow fiber membranes are effectively potted (FIG. 1i).

As can be seen from FIGS. 1h and 1i, the method in which the wax is melted from the bores of the hollow fiber membranes produces a potted hollow fiber bundle (FIG. 1h) that retains more of the hollow fiber membranes (that is, less hollow fiber membrane is removed) than the method in which the entire section of the hollow fiber membrane bundle containing wax is removed (FIG. 1i). It can be seen that the length of the module of FIG. 1h is greater than that of the module of FIG. 1i.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.
[1]: Chen et al. (2018). Module scale-up and performance evaluation of thin film composite hollow fiber membranes for pressure retarded osmosis. Journal of Membrane Science, 548, 398-407.

1. A method of potting a hollow fiber bundle comprising a plurality of hollow fiber membranes, the method comprising the following steps:
(i) a first potting step comprising filling one end of the hollow fiber membranes of the hollow fiber bundle with a first potting compound and allowing the first potting compound to solidify so as to seal the ends of the hollow fiber membranes, and then agitating the sealed end of the hollow fiber bundle;
(ii) a second potting step comprising submerging the sealed end of the hollow fiber bundle in a liquid second potting compound and allowing the second potting compound to solidify so as to encase the sealed end of the hollow fiber bundle within the solid second potting compound; and
(iii) a cutting step comprising cutting through the encased portions of the hollow fiber bundle so as to expose the bores of the hollow fiber membranes.

2. The method according to claim 1 wherein the first potting compound is a wax.

3. The method according to claim 2 wherein the wax is a petroleum wax,

4. The method of claim 1 wherein, in step (i), the filling is done by submerging one end of the hollow fiber membranes of the hollow fiber bundle in a liquid first potting compound.

5. The method of claim 1 wherein the hollow fiber bundle comprises more than 200 hollow fiber membranes.

6. The method of claim 1 wherein the potting removal step comprises using heat, a solvent, or both to selectively remove the first potting compound.

7. The method of claim 1 wherein the second potting compound is an epoxy resin or a urethane resin.

8. The method of claim 2, wherein the wax is candle wax.
